(19) United States
(12) Patent Application Publication
(10) Pub. No.: US 2018/0029726 A1
(43) Pub. Date: Feb. 1, 2018

(54) Solar Storm Warning System

(71) Applicant: Denise Jones, Hamburg (DE)

(72) Inventor: Denise Jones, Hamburg (DE)

(21) Appl. No.: 15/550,178

(22) PCT Filed: Feb. 10, 2016
(86) PCT No.: PCT/EP2016/000222

§ 371 Date: Aug. 10, 2017

(30) Foreign Application Priority Data
Feb. 10, 2015 (DE) 10 2015 001 549.4

(51) Int. Cl. B64G 1/10; H04B 7/185; G01W 1/00; G01F 1/58; B64G 1/24; B64G 1/66

(52) U.S. Cl. CPC B64G 1/105; B64G 1/1085; B64G 1/242; B64G 1/66; G01W 1/00; G01F 1/58; H04B 7/18513; B64G 2001/1064

(57) ABSTRACT

The invention relates to a satellite-supported solar storm early warning system for providing a warning signal upon approach of a solar storm to Earth, comprising a number of satellites in a region between the Earth and the Sun and stationary with respect to the center of the Earth and to the connecting line between the Earth and Sun, which satellites are respectively equipped with at least one sensor for measuring at least one parameter of a particle flow in the surroundings thereof, and all of which satellites are in radio signal connection with a receiver on Earth, directly and/or via a satellite or one of the satellites, and each of which satellites is equipped to transmit a measured value of a sensor of the system and/or a warning signal upon exceeding a threshold value by a measured value of a sensor of the system to the receiver via the radio signal connection.

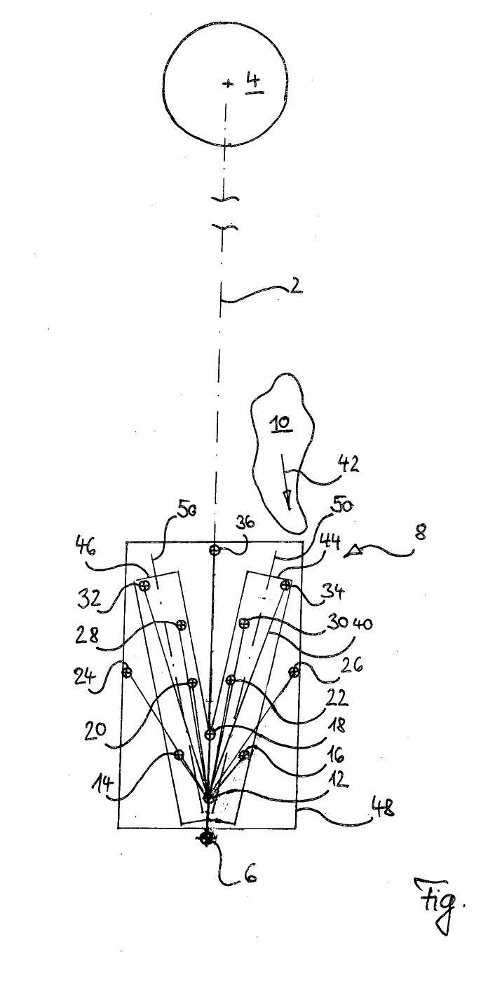

The present invention concerns a solar storm warning system for providing a warning signal upon the approach of a solar storm of charged particles to Earth.

“Solar wind” is a flow of electrically charged particles which disperse in all directions from the sun due to flares. Solar “storms”—also known as “geomagnetic storms” are known to arise from particularly strong solar flares. These particle flows are primarily comprised of protons, electrons and helium nuclei (alpha particles). Earth's magnetic field shields it from such a cloud of particles streaming toward the Earth. However, depending on the strength of the flow, the Earth's magnetosphere is at least changed in shape and strength for the duration of the exposure.

For example, an unusually strong solar storm can cause the particle flow to penetrate through to the surface of the Earth. It can influence technology, civilization and life on Earth, even endanger these to a catastrophic extent, by electrical and magnetic effects first of all on the Earth's magnetic field and then particularly on electrical equipment and electronics of any kind. Magnetism resulting from the electrically charged particles and electrical storms resulting from them can overload the systems and cause failure, as happened historically in the Carrington event in 1859 (which would probably have had truly devastating effects only in current times, because at that time the electrical system on Earth was essentially limited to telegraph lines, but it led to aurora borealis effects visible not only at the North Pole but also in Rome, for example) and multiple times already after that (although only to a limited extent up to now). For several years now, statistical probability has led to fears that a magnetic storm of even greater magnitude than the Carrington event directed at the Earth is to be expected, with catastrophic effects and consequences due to the ubiquitous presence of electrical and electronic systems today.

Details are uncertain, but influence on the climate and natural world is to be expected too, on tides, for example, with consequences possibly as catastrophic as with a tsunami. Just as an example, the failure of electronic systems can cause aircraft crashes and power network disruption with obviously severe or catastrophic secondary consequences.

The objective of the present invention is to create a system which provides timely warning of solar storms so that measures can be taken to prevent disruptive or destructive consequences in time.

This objective is accomplished by a system with the features of claim 1. Preferred embodiments are specified in the dependent claims.

The invention is a satellite-supported early warning system for solar storms. It is used to generate a warning signal and transmitted to a receiver on Earth upon the approach of a solar storm to Earth and do so in such a timely manner that measures to prevent disruptive or destructive consequences can be taken in time before it arrives with the resultant excessive magnetism. Only as an example, aircraft can then be landed or diverted and, power plants can be shut down and electrical and electronic devices in general and technology control by such, for instance, can be switched off and their operation deliberately stopped to avoid or at least reduce damages.

The inventive early warning system has a number of satellites (possibly exclusively or also nanosatellites or nanoprobes), which are in a region between the Earth and Sun (and possibly other satellites—once again possibly also nanosatellites or nanoprobes as well—outside this region). The satellites are configured to be “stationary” with respect to the center of the Earth and remain positioned on the connecting line between Earth and the Sun, and thus assume as constant a position as possible in the court in its system comprised of the Earth's center (as zero, for example) and a connecting line between the Earth and Sun (for example as a base line for angular coordinates).

The satellites are each equipped with at least one sensor “for measuring a parameter of a particle flow in its environment”, which is in particular configured to measure at least one physical variable in its environment, the magnitude of which changes or does so in the environment of a solar wind or solar storm (for example to the extent already measured, correlated or the hypothetical, calculated extent determined for a solar wind or storm), with highly relevant examples particularly including magnetometers, thermometers, spectrometers, ultrasound sensors, mass spectrometers and/or measuring units for radioactivity or gamma radiation. This preferably concerns at least one magnetometer, sensors for measuring the magnetic field strength in the environment or of the influencing magnetic field. These sensors can also be used by an apparatus of the satellite for navigation or determining its position in space, particularly with respect to the Earth's magnetic field and thus also with respect to the center of the earth and the connecting line between Earth and the Sun.

The satellites are all connected by radio signal with a receiver (a receiving station) on Earth, directly and/or via other satellites of the system (or at least via one other satellite).

Preferably, one of the satellites (in particular the one closest to Earth) which is directly connected to by radio signal with the receiver on Earth is located as a “main satellite” at Lagrange point 1 of the Sun-Earth system, where satellites can maintain their position especially well with particularly little energy expenditure. All other satellites of the system are preferably (and possibly exclusively) connected directly with this one satellite by radio signal.

Each of the satellites is configured to send signals to the receiver or the receiving station via the radio signal connection and in fact receive a measured value, particularly from the sensors (particularly measured by the magnetometer) and/or a warning signal, which is produced upon exceeding a limit value by a signal processing device on the satellite with the magnetometer or sensor which measured the value or on the path of the radio link (in particular on another satellite of the system, for example the main satellite or yet another satellite). Preferably, (at least) one inventive satellite can also have sensors onboard which detect more than one physical parameter in order to measure and thus investigate astronomical parameters and in particular characteristics of solar wind and solar storms.

According to our knowledge today, a solar storm has the form of a “cloud” of the charged particles initially mentioned. It has a considerable extent, particularly transverse to its direction of movement as well (away from the Sun, possibly threateningly toward the Earth), particularly with a cross-sectional area (even considerably) greater than the area of the Earth's circle. It will be possibly influenced by the Earth's magnetic field in the direction of the Earth and in passing by it, so that a cloud on a straight path which would not encounter the Earth can be diverted in an arc toward it. According to the invention, measurements from the sensors in the system can provide information about the course of the path and in particular the speed and distance from the Earth as well for such a solar storm directed toward the Earth in a threatening manner.

The distance between the satellites preferably comprises less than 3 million kilometers, with particular preference less than 2 million kilometers, as for example 1.5 million kilometers or a distance which permits a radio or signal connection to be established securely. Thus preferably at least indirectly via system satellites more proximate to the Earth or still other satellites more proximate to the Earth a signal connection can be established securely and with as little interference as possible with the receiver on Earth—but preferably also in particular by compensating the time difference of measurement values (their change and/or magnitude indicating presence and/or approach and are correlated therewith or at least suspected to be) of various system satellites with the distance and/or position coordinates of these satellites with respect to one another and/or with the Earth—to receive information on the path of the solar storm, its speed and distance from the Earth.

Measurement values with “solar storm significance” at one of the satellites and somewhat later at a second satellite can enable due to their known positions the determination of information on the path, speed and distance from the Earth of the particle cloud in a possible data processing device for the system (at the receiving station and/or on the main satellite, for example). If this path leads to the Earth, the system will trigger a warning signal. If, for example, somewhat later a measurement of a third satellite even closer to the Earth continues to show unchanged values, particularly ones which are not of “solar storm significance”, this indicates that the cloud is not on the path to Earth but instead will pass by it, and the system can give the all-clear signal.

Preferably the distance of (at least) the satellite farthest from Earth comprises less than 50 million kilometers from the Earth, particularly preferably less than 20 million kilometers, for example 10 million kilometers—or (at least) a distance at which the approaching solar wind takes a time which allows electric and electronic facilities, units, as well as technology controlled by such units, circuits or chips, for example, to be switched off in a controlled manner and deliberately taken out of operation to avoid or at least reduce damages.

An example is a V-shaped arrangement of satellites with two 9 million kilometers distant (for example, according to our knowledge today with about 2.6 hours remaining until the solar storm reaches Earth), two at about 7.5 million kilometers (about 2.2 hours travel time), two at about 6 million kilometers (about 1.8 hours travel time), two at about 4.5 million kilometers (1.3 hours travel time), two at about 3 million kilometers (about 50 minutes travel time) and one (at Lagrange point 1 of the Sun-Earth system) at about 1.5 million kilometers (about 1.5 hours travel time) distant. This enables a solar storm to be detected earlier in the region of the satellites of the inventive system (i.e. in possibly threatening proximity to Earth) by the travel time of the solar storm to the earth so measures to prevent disruptive or destructive consequences can be taken on Earth in a timely manner.

The satellites of the system can be configured to send a measurement signal of a system sensor (particularly from their own onboard sensors) and/or a control signal to the receiving station via the radio signal connection at regular intervals (for example every minute, every quarter hour, every half hour or hourly), preferably to enable solar storm monitoring preferably for possible necessary triggering of a warning signal reliably and as early as possible in this timing cycle, but preferably possibly also to check that the satellites are working and are not (if the routine signal is not sent), for example, already disrupted and/or rendered dysfunctional by the influence of solar wind.

According to our knowledge today, a solar wind or solar storm has the shape of a cloud, not only throughout its extent with varying density or concentration of the charged particles initially mentioned. It will be (in addition to its considerable extension in particular also transverse to its direction of motion away from the Sun) influenced by the Earth's magnetic field in the direction of the Earth and in passing by it, so that a cloud on a straight path that would not encounter the Earth nonetheless, for example, can be diverted in an arc toward it.

In order to position satellites of the inventive system such that a cloud which is on a straight or even a curving diverted path contacting the Earth, contacts at least one of the satellites beforehand and can be measured by its magnetometer and/or other sensors as at least one measurement value of “solar storm significance”, for example in the form of increased magnetism or increased magnetic field strength, at least one, but also more or all of the satellites are preferably arranged as follows, and in fact alternatively or cumulatively.

The satellites preferably comprise a linear formation; in particular at least one satellite is on a straight line between Earth and the Sun.

They preferably comprise a V-shaped formation in which the V (for example essentially in a plane at a right angle to the equatorial plane of the Earth but also (approximately) in any other plane) is opened in the direction of the sun from the Earth, preferably with a width of opening for the V greater than the diameter of the Earth.

The satellites are arranged stationary, in two elongated or linear subregions, with the line of connection between the Sun and Earth as a line of symmetry for the two subregions.

The satellites are stationary symmetric to the connecting line between the Sun and Earth as a line of symmetry between two satellites in each case.

The satellites are arranged stationary, in two elongated or linear subregions in a V-shape with respect to one another and with the tip of the V in the direction of Earth.

The satellites are stationary in a region extending in the shape of a straight circular cylinder with the connecting line between the Sun and Earth as a cylinder axis and with a diameter less than about 10 times or 5 times or 3 times the Earth's diameter (of about 13,000 km),

The satellites are stationary in a region extending in the shape of two straight circular cylinders whose cylinder axes are situated with respect to one another in a V-shape with the connecting line between the Sun and Earth as a line of symmetry for the two cylinder axes arranged in a V-shape with respect to one another and with a distance of the satellite farthest from Earth in the one circular cylindrical subregion to the satellite farthest from Earth in the other circular cylindrical subregion greater than about 10 times or 5 times or 3 times the diameter of each of the two cylinders.

Other advantages, embodiments and details of the invention are detailed below in the description of an embodiment with reference to the FIGURE included.

The FIGURE shows a schematic top view of an inventive satellite-supported solar storm warning system in its arrangement with respect to the Sun and Earth.

The FIGURE shows an (approximately scale) schematic top view of the connecting line 2 between the Sun 4 above as a circle (known to be about 1.4 million kilometers diameter, i.e. at a scale of about 1:100 million) and Earth 6 (known to be about 13,000 km in diameter) below as Point 6 (drawn with a cross). With regard to this an inventive satellite-supported solar storm warning system 8 is shown with its satellites in an inventive arrangement with respect to the Sun 4 and Earth 6.

It is used to generate a warning signal and transmit it to a receiver on Earth 6 upon the approach of a solar storm 10 to Earth and do so in such a timely manner that measures to prevent disruptive or destructive consequences can be taken in time before it arrives with the resultant excessive particle stream. Only as an example, aircraft can then be landed, power plants can be shut down and electrical and electronic units in general and technology control by such, for instance, can be switched off in a controlled manner and their operation deliberately stopped to avoid or at least reduce damages.

The early warning system 8 has thirteen 12 to 36 which are stationary in a region 38 between the Earth 6 and the Sun 4 considerably closer to the Earth then to the Sun. Satellites 12 to 36 are equipped in each case with sensors (not shown) for measuring the magnetic flux density and other physical parameters of “solar storm significance” in their environment.

The satellites 12 to 36 all have a radio and signal connection 40 (illustrated by the lines between the satellites 12 to 36 and the Earth 6) with a receiving station (not shown) on the Earth 6, direct in fact (i.e. the “main satellite” 12 closest to Earth at the first Lagrange point 12 of the Sun-Earth system) and the other system satellites 14 to 36 of the system are connected via the main satellite 12. Each of the satellites 12 to 36 is configured to send signals to the receiving station (not shown) on the Earth 6 via this radio signal connection 40 containing a measurement value of “solar storm significance” (particularly measured by the respective sensor (not shown) and if necessary a warning signal which is produced by a signal processing device (not shown) on the satellite 12 to 36 when a limit value is exceeded if it measures a value of “solar storm significance”.

According to our knowledge today, a solar storm 10 has the form of a “cloud” 10 of the charged particles initially mentioned. It has a considerable extent, particularly transverse to its direction of movement 42 as well (away from the Sun 4, possibly toward the Earth 6), particularly with a cross-sectional area (even considerably) greater than the area of the Earth's circle. It will be possibly influenced by the Earth's 6 magnetic field in the direction of the Earth 6 and in passing by it, so that a cloud 10 on a straight path 42 which would not encounter the Earth 6 can be diverted in an arc toward it. In the example depicted, measurements from the sensors (not shown), particularly of satellites 34, 26 and 16 can provide information about the further course of the path of the solar storm 10. After higher values at the satellite 34 and somewhat later at satellite 26 (from which the speed of the cloud 10 can be calculated from their known distance with respect to one another) a measurement at satellite 16 after the same interval gives a normal value and indicates that the cloud has not taken the arced path toward Earth (on which satellite 16 is located with respect to the two satellites 34 and 26) but instead is moving past it.

The distance between the satellites 12 to 36 is about 1 million to 1.5 million kilometers.

In order to position the satellites 12 to 36 of the system 8 so that a cloud which would encounter the Earth 6 on eight straight or arced path, contacts at least one of the satellites beforehand and enables its increased magnetism or greater particle concentration to be measured by its sensor (not shown), the satellites are arranged as follows.

Satellites 12, 18 and 36 comprise a stationary linear formation on a straight line 2 between the Earth 6 and the Sun 4,

The satellites 12 to 34 comprise a stationary V-shaped formation 44, 46 in which the V 44, 46 is opened from the Earth 6 in the direction of the Sun 4—with the width of the opening of the V at various distances with respect to the Earth 6 (distances of the paired satellites 14, 16 and 20, 22 and 28, 30 arranged stationary and symmetrical with respect to the connecting line 2 between the Sun 4 and to the Earth 6 as a line of symmetry) being considerably greater than the Earth's diameter.

Satellites 12 to 22 and 28 to 34 are arranged stationary in multiple elongated or linear subregions (for example 44, 46), in each case with the connecting line 2 between the Sun 4 and Earth 6 as a symmetry line for the two respective subregions.

Satellites 14, 16 and 20 to 34 are stationary symmetrical to connecting line 2 between the Sun 4 and Earth 6 as a line of symmetry between two satellites in each case.

Satellites 12 to 22 and 28 to 34 are arranged stationary in multiple elongated or linear subregions in a V shape with respect to each other (for example, 44 and 46), with the tip of the V in the direction of Earth 6.

The satellites 12 to 36 are stationary inner region extending in the shape of a straight circular cylinder (its rectangular side view 48 is shown) with the connecting line 2 between the Sun 4 and Earth 6 as a cylinder axis and with a diameter somewhat greater than the diameter of the Sun.

The satellites 12 to 22 and 28 to 34 are stationary in a region extending in the shape of two straight circular cylinders (their respective rectangular side view 44 and 46 is shown) whose cylinder axes are situated with respect to one another in a V-shape with the connecting line 2 between the Sun 4 and Earth 6 as a line of symmetry for the two cylinder axes 50 arranged in a V-shape with respect to one another and with a distance of the satellite 32 farthest from Earth in the one circular cylindrical subregion 46 to the satellite 34 farthest from Earth in the other circular cylindrical subregion 44 greater than about 3 times the diameter of each of the two cylinders 44, 46.

1. A satellite-supported solar storm early warning system for providing a warning signal upon approach of a solar storm to Earth, the system comprising a plurality of satellites in a region between the Earth and the Sun and stationary with respect to the center of the Earth and to the connecting line between the Earth and Sun, wherein the satellites are respectively equipped with at least one sensor for measuring at least one parameter of a particle flow in the surroundings thereof, and all of the satellites are in radio signal connection with a receiver on Earth, directly and/or via a satellite or one of the satellites, and wherein each satellite is equipped to transmit a measured value of a sensor of the system, a warning signal, or both, upon exceeding a threshold value by a measured value of a sensor of the system to the receiver via the radio signal connection.

2. The system according to claim 1, wherein one of the satellites is in a direct radio signal connection with the receiver on Earth at Lagrange point 1 of the Sun-Earth line system.

3. The system according to claim 1, wherein the satellites form a V-shaped formation with the V opened toward the Sun from the Earth.

4. The system according to claim 1, wherein the region has two elongated or linear subregions with the connecting line between the Sun and Earth as a line of symmetry for the two subregions.

5. The system according to claim 1, wherein the subregions are arranged in a V shape with respect to each other with the tip of the V in the direction of Earth.

6. The system according to claim 1, wherein the region has an extension in the shape of a straight circular cylinder with the connecting line between the Sun and Earth as a cylinder axis and with a diameter less than three times the diameter of Earth.

7. The system according to claim 1, wherein:
the region has an extension in the shape of two straight circular cylinders whose cylinder axes are arranged in a V shape with respect to each other with the connecting line between the Sun and Earth as a line of symmetry for the two cylinder axes arranged in a V shape with respect to each other; and
the distance of the satellite farthest from Earth in the one circular cylindrical region to the satellite farthest from Earth in the other circular cylindrical region is greater than five times the diameter of each of the two cylinders.

8. The system according to claim 1, wherein the distance between the Earth and the satellite farthest from Earth is less than 50 million km.

9. The system according to claim 1, wherein the distance between the satellites is less than 3 million km.
